(19) United States
(12) Patent Application Publication
(10) Pub. No.: US 2001/0008441 A1
(43) Pub. Date: Jul. 19, 2001

(54) Process for printing photographic proofs intended to facilitate the reprinting of proofs

(75) Inventor: Thierry Vachette, Esbarres (FR)

Correspondence Address: Patent Legal Staff, Eastman Kodak Company, 343 State Street, Rochester, NY, 14650-2201, US

(73) Assignee: Eastman Kodak Company

(21) Appl. No.: 09/758,572

(22) Filed: Jan. 11, 2001

(30) Foreign Application Priority Data
Jan. 19, 2000 (FR) 0000615

(51) Int. Cl. G03B 27/52

(52) U.S. Cl. 355/39; 355/40; 355/77

(57) ABSTRACT

The present invention relates to a process for printing photographic proofs from an image storage medium containing at least one recorded image or shot. The process comprises in addition to the steps of printing photographic proofs the steps of recording data which identifies the at least one shot on the image storage medium, that can be read when reprinting; printing the data on at least one first medium; and arranging the at least first medium on the proof corresponding to the at least one identified shot, the at least first medium being removable from the proof corresponding to the at least one shot so as to be affixed to a second medium intended to order a reprint.

### FIELD OF THE INVENTION

The present invention relates to a process for printing photographic proofs intended to facilitate the operation of reprinting proofs.

### BACKGROUND OF THE INVENTION

To make reprints of photographic proofs, the user has to write the number of proofs to be reprinted linked with an order number of the shot he/she wishes to have reprinted, the number having been marked either directly on the film negative, or on an index especially in the case of APS format films. The user then writes this number on a special form to order the reprints. However, sometimes it is difficult to determine easily the number to which a shot corresponds from a 24/36 format negative. Further, it is not always easy to recognize the shot that is wanted for reprinting whether on an index or on a negative given that the shots on the negative or the thumbnail images on the index have a small format that does not enable recognition of the shot's details. Besides, if only the negative is available, it is still more difficult to recognize the shot given that the colors are not reproduced. In addition, there is always a risk of error when a box corresponding to the chosen shot number has to be checked given that the user has to match at least two separate items at the same time, i.e. the photo and the form, or even the negative as well. Further, the operation of the developing lab which comprises reading the reprints form is not always error free especially when boxes have been checked in error and then crossed out.

Processes facilitating the reprinting of shots have been described in Research Disclosure August 1978, Number 17254. Such processes include using a medium, e.g. a disk, containing the negatives for each shot. One or more locations are provided on the medium, which are linked with each shot, to enable the user to write the necessary information so that the chosen shots are reprinted.

### SUMMARY OF THE INVENTION

It is an object of the invention to provide a printing process for photographic proofs that facilitates the operation of reprinting proofs, both for the holder of the photos and for the developing lab or for the printer of digital images.

The invention relates to a printing process for photographic proofs from an image storage medium containing at least one recorded image or shot, a process that comprises in addition to the steps of printing photographic proofs the following steps:

recording data which identifies the at least one shot on the image storage medium, that can be read when reprinting;

printing the data on at least one first medium; and

arranging the at least first medium on the proof corresponding to the at least one identified shot, the at least one first medium being removable from the proof corresponding to the at least one shot so as to be affixed to a second medium intended to order a reprint.

The invention also relates to a method for reprinting a proof from an image storage medium on which is recorded at least one shot, a method which comprises the following steps:

receiving, along with the image storage medium, a card on which is affixed at least one medium on which is recorded data which identifies at least one shot on the image storage medium that has to be reprinted;

reading the data to identify which shot of the image storage medium has to be reprinted; and

printing the proof corresponding to the identified shot from the image storage medium.

### BRIEF DESCRIPTION OF THE DRAWINGS

FIG. 1 is a schematic diagram illustrating the process of printing proofs in accordance with the present invention;

FIG. 2a is a plan view of the front surface of the first medium;

FIG. 2b is a plan view of the back surface of the first medium;

FIG. 3 is a plan view of the second medium; and

FIG. 4 is a schematic diagram illustrating the method for reprinting a proof in accordance with the present invention.

### DETAILED DESCRIPTION OF THE INVENTION

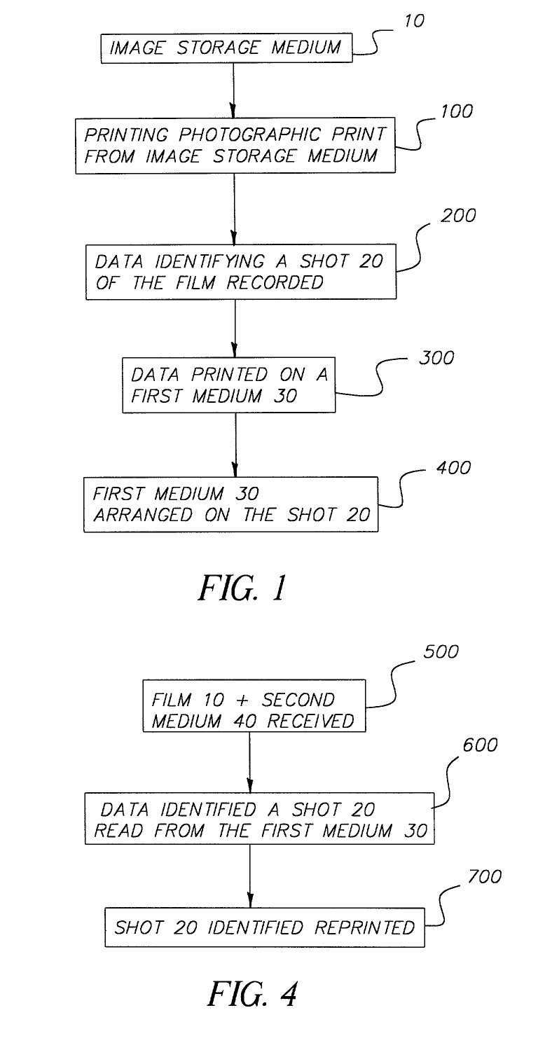

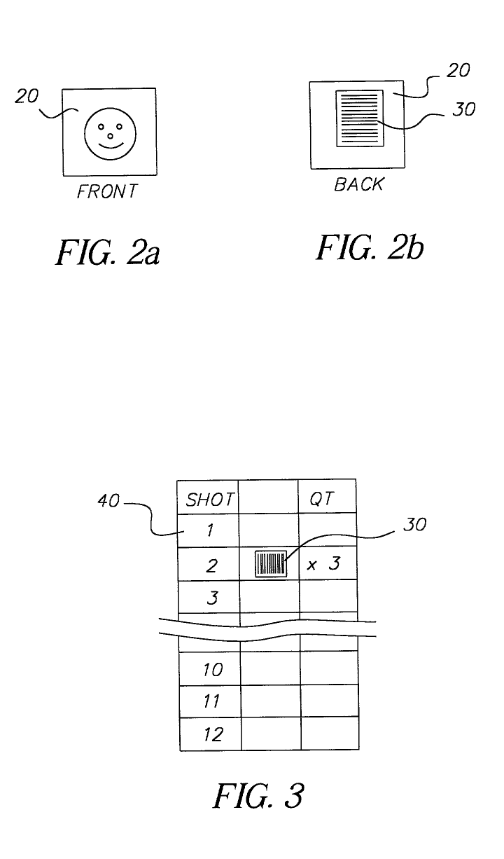

The process of the present invention is a process, which is illustrated schematically in FIG. 1. The process includes printing photographic proofs (step 100) from an image storage medium 10 such as film. The step of photographic proof printing 100 is known to those skilled in the art. The process also includes the step 200 of recording data identifying each image or shot 20 (FIG. 2a) recorded on the storage medium 10. The image storage medium 10 is for example a photographic film of 24/36 format or an APS format film. It is clear that other media containing digital images can be used as, for example, a CD-ROM or again a Photonet® account on an Internet type network. In the case of digital type media, photographic printing means printing the digital images on paper, e.g. printing using an inkjet, thermal or again laser printer. The recorded data is then printed (step 300) on a first medium 30 (FIG. 2b). The recorded data is intended to be read when shots are reprinted. Data corresponding to each shot 20 is thus printed on the first medium 30 that can be affixed to the corresponding proof. Preferably, as illustrated on FIGS. 2a and 2b, the first medium 30 is affixed to the back of the corresponding image on the shot 20. It is also possible to envisage affixing the first medium 30 to the front of the proof, e.g. in a margin. Clearly data identifying a shot can be printed on several first media, these media being able to be affixed to the same corresponding proof.

The content of the printed data must enable identification of the shot to be reprinted. For this purpose, this data contains for example the shot number. In the case of APS film, it can also be planned to include the number of the film on which the shot is located so as to check that the given film is that containing the shot to be reprinted.

The data to be printed can be encoded. For example it can be planned for it to be encoded in the form of a barcode, as illustrated on FIG. 2b. Clearly any other form that can be read fast can be used. In particular the use of the number linked to each shot can be planned, which can be scanned easily before reprinting, or again a combination of these codes.

The first medium 30 on which the data identifying the shot is printed is preferably a medium that can be detached and reused. For example a self-adhesive medium of the Post-its type is used. Thus, the medium can be stuck, unstuck and restuck. Clearly any other type of detachable and reusable medium can be used, like for example self-adhesive labels having a base that enables them to be removed easily from their medium and placed firmly on the second medium used for reprinting.

When printing the photographic proof, the data identifying each shot is planned to be recorded and printed on the first medium. The first medium, then called the label, on which is printed the data identifying a shot, is then stuck first on the proof corresponding to this shot. As was shown above, several identical labels can be planned to be stuck to the same proof so as to enable several consecutive or simultaneous reprints to be made. Thus, when the user receives the prints of his/her photos, at least one label is present on each proof. To make the reprints, the user just has to unstick the label provided on the chosen proof and to stick it onto the second medium indented to order the reprints.

The second medium 40 which is illustrated in FIG. 4, is a form for ordering reprints from proofs. It is for example a card or again a sleeve into which the image storage medium holding the shots to be reprinted is inserted, or in the case where Photonet is used, the account references. The form is intended to take the self-adhesive labels 30 arranged by the user who has unstuck them from the corresponding proofs. The form can be a simple card or a simple sleeve on to which the user sticks the labels corresponding to the chosen proofs. The user can write additional information on the form, e.g. the number of reprints of the chosen shot, its quality, i.e. mat or glossy, or again its size, etc. The user can of course stick onto the same reprinting form different labels corresponding to different shots of the same film that he/she attaches to the form and also several identical labels to ask for as many reprints of the same proof as there are labels. Preferably the form is a preprinted form that helps the user to make his/her order. In fact various boxes are provided, especially a box in which the labels are stuck. Linked to this box, various boxes are planned enabling the user to define his/her order. For example a box is provided to write the quantity of the reprint, a box for indicating the chosen size, and/or a box for choosing the print quality (mat or glossy).

Such a form enables the user to identify clearly and easily the shots to be reprinted and to order them easily. It also enables the developing lab to read easily and thus clearly identify the shots chosen by the user using a barcode reader or a scanner. It can be envisaged for this step to be automated so as to save time.

This form 40, along with the image storage medium, is thus received (step 500) (FIG. 4) by the developing lab, from the customer. At least one medium 30 on which is recorded data which identifies at least one shot 20 on the image storage medium 10 that has to be reprinted is affixed on this form 40. The data identifying the shot 20 is read (step 600), to identify which shot of the image storage medium has to be reprinted. Finally, a proof corresponding to the identified shot 20 from the image storage medium 10 is reprinted.

Clearly this process can be used in existing printing processes in which a number identifying a shot is written on the back of the proof corresponding to this shot. Thus, if the user wishes to make proof reprints when all the labels provided on the back of the proof have already been used, he/she can order the reprints according to the conventional process.

The invention has been described in detail with particular reference to certain preferred embodiments thereof, but it will be understood that variations and modifications can be effected within the spirit and scope of the invention.

1. A process for printing photographic proofs from an image storage medium on which is recorded at least one image, the process comprising the steps:
recording data which identifies the at least one image on the image storage medium, that can be read when reprinting;
printing the data on at least one first medium; and
arranging the at least one first medium on a proof corresponding to the at least one identified image, the at least one first medium being removable from the proof corresponding to the at least one image so as to be affixed to a second medium intended to order a reprint.

2. A process according to claim 1 wherein the at least first medium is arranged on the back of the proof.

3. A process according to claim 1 wherein the data contains an image number.

4. A process according to claim 3 wherein the data further contains a number identifying a film.

5. A process according to claim 1 wherein the data is printed in the form of a barcode.

6. A process according to claim 1 wherein the first medium is a detachable and reusable medium.

7. A process according to claim 6 wherein the first medium is a self-adhesive detachable and reusable medium.

8. A method for reprinting a proof from an image storage medium on which is recorded at least one image, the method comprising the steps of:
receiving, along with the image storage medium, a card on which is affixed at least one medium on which is recorded data which identifies at least one image on the image storage medium that is to be reprinted;
reading the data to identify which image of the image storage medium is to be reprinted; and
printing a proof corresponding to the identified image from the image storage medium.
